(19) United States
(12) Patent Application Publication
(10) Pub. No.: US 2005/0259991 A1
(43) Pub. Date: Nov. 24, 2005

(54) Method of establishing communication through free space between a pair of optical communication devices

(75) Inventors: Alexander Dudelzak, Nepean (CA); Alexander Kuzhelev, Quebec (CA); Alexander Novikov, Hampstead (CA); Guerman Pasmanik, Toronto (CA)

Correspondence Address: MARKS & CLERK, P.O. BOX 957, STATION B, OTTAWA, ON, K1P 5S7, CA

(73) Assignee: National Research Council of Canada, Ontario (CA)

(21) Appl. No.: 10/507,603

(22) PCT Filed: Mar. 17, 2003
(86) PCT No.: PCT/CA03/00392

§ 371 Date: Jun. 20, 2005

Related U.S. Application Data
(60) Provisional application No. 60/365,508, filed on Mar. 20, 2002.

(51) Int. Cl. H04B 10/00

(52) U.S. Cl. 398/118

(57) ABSTRACT

A method is disclosed for establishing communication through free space between a pair of optical communication devices. A divergent beam is transmitted from each of the optical communication devices toward the other. A portion of the received divergent beam is used to create a phase conjugated beam that is returned to the other device. A diffraction grating is dynamically recorded at each devices so as to establish a bi-directional self-tracking optical link between the devices.

### CROSS REFERENCE TO RELATED APPLICATION

This application claims the benefit under 35 USC 119(e) of prior U.S. Provisional application No. 60/365,508, filed Mar. 20, 2002, the contents of which are herein incorporated by reference.

### FIELD OF THE INVENTION

This invention relates to the field of optical communications, and in particular, to a method and an apparatus for establishing optical communication through free space between a pair of optical communication devices. The invention is, for example, applicable to optical communication between orbiting satellites.

### BACKGROUND OF THE INVENTION

When optical communication is established between satellites, some means must be found to keeping the optical beam pointing at the target in order for communications to take place. Existing optical beam control techniques limit the capabilities and performance of spatial and temporal light modulators (such as in pointing, deflecting, cross-switching and other systems for optical telecommunications, artificial vision and other electro-optical/photonics applications in space and on the ground). For example, one of the main challenges in achieving ultra-high bit-rates for optical inter-satellite (OISL) and other communication links has been precision beam control.

Communication inter-satellite, satellite-to-ground, and ground-to-satellite cross- links are currently provided by radiofrequency (RF) transceivers. While RF technology is technically mature, these systems suffer from certain shortcomings. Duplex RF systems come at generally high cost, therefore simplex systems are widely employed at a price of allowing communication in one direction at a time. In addition, the frequencies available for RF satellite communication are currently very limited. Finally, RF systems offer limited rates for data transmission.

High data rate station-to-station optical communication through free space is afforded by the use of a very narrow optical beam. Acquisition and tracking of the narrow beam is problematic in that the beam must be pointed at a remote transceiver with microradian accuracy. Optical beams of sufficient brightness are typically tens of microradians in diameter, while the corresponding requirement for RF beam widths is generally on the order of one to two degrees. Prior optical communications concepts relied on power consuming optical beacons for initial acquisition. An alternative approach involves scanning of a diffraction limited transmit beam over the region of pointing uncertainty in order to illuminate the remote transceiver. Since the narrow angle transmit beam of both transceivers must be scanned and finally co-aligned (while taking into account the pointahead angle), the acquisition process is very time consuming making it a costly solution.

Other methods using electromechanical deflection devices rely on the concept of each transceiver autonomously tracking the image of the other's transmit beam. Many optical communications systems incorporate an expensive charge coupled device (CCD) image sensor or an image-splitting device followed by a quadrant detector. The principle of operation of such system can be briefly explained as follows. A separate pointing and tracking signal is used as a “beacon,” for determining the amount of mechanical steering. A lens focuses an incoming beam onto a CCD-matrix in order to obtain angular coordinates of the transmitter. The discrepancy signal between the directions of the incoming and outgoing beams controls a motorized mirror that moves, making the beams coincide. Since the dynamic range of the pointing error is large (e.g., 1,000:1), a single-stage tracker is not feasible, especially when the communication data rates are considered. Therefore, a coarse-fine implementation with dual detector complements has been the usual approach. Furthermore, the as communicating devices are moving relative to each other, to achieve efficient functioning of such a modulator it is necessary to predict positions of the transmitter and the receiver precisely enough that the narrow beam of the communication laser does not miss the remote target moving along not that precisely defined orbit. Relative to optical steering systems, these systems are typically complicated and expensive increasing the payload weight and the signal acquisition time.

From the mid 1980s to date, the OISL transmission rate has grown from 1 Mbps to 50-1200 Mbps [3-5] and now promises to reach 2.5 Gbps and higher. Optical cable links now require light switches/deflectors capable of working with terabit transmission rates. Free-space communication links also use fibers on both the transmitting and receiving ends. The electro-mechanical beam-deflecting techniques fundamentally limit a link performance to the Gbps range. This causes serious difficulties with directing a received optical signal to a single-mode telecommunication fiber for further DWDM (Dense Wavelength Division Multiplexing). In turn, it presents one of the most important difficulties making viable a substantial increase in the number of multi- wavelength channels in the same fiber.

U.S. Pat. No. 5,317,442 describes a method of establishing communication for IFF purposes using mutual pumped phase conjugation. This patent uses the same beam to provide phase conjugation and communication.

WO 0178262 discloses a method optical tracking using non-degenerate four- wave mixing between moving objects. This patent only also uses a single beam, which does not permit a point-ahead mechanism to be employed if necessary.

### SUMMARY OF THE INVENTION

Thus, there has been a need in the art of free space optical communications for an all-optical method of beam control and automatic coupling of two distant laser sources.

The present invention adopts a novel, all-optical approach in beam control/deflection/tracking techniques based on combination of optical wave phase conjugation and optical dynamic holography. The advantage of this approach is that it allows achieving automatic, self-controlled coupling of beam emitters and receivers (e.g. optical fibers or distant telecommunication satellites). The proposed approach is based on using nonlinear optical materials, in which the so-called Double Phase Conjugation (DPC, also known as mutual phase conjugation, or double-pumped phase conjugation) can be realized with low light intensity. Combining the DPC phenomenon with dynamically recorded diffraction grating in these materials allows a bi-directional optical link to be established between a transmitter and a receiver with an automatic tracking feature. The concept eliminates the need for ultra-precise mechanical steering elements as well as complicated positioning and addressing computing. One of the important results is the potential increase in the performance levels of both the ground optical fiber and intersatellite communication links.

Accordingly in a first aspect the present invention provides a method of establishing bi-directional self-tracking optical communication through free space between first and second optical communication devices, comprising generating at said first and second optical communication devices respective first and second outgoing beams, each of said first and second outgoing beams comprising a signal beam and a pilot beam; diverging said first outgoing beam and transmitting said divergent first outgoing beam from said first optical communication device toward said second optical communication device, and diverging said second outgoing beam and transmitting said divergent second outgoing beam from said second optical communication device toward said first optical communication device; dynamically recording at each of said first and second optical communication devices a holographic grating with said first and second outgoing beams thereby creating a phase conjugated version of said first outgoing beam at said second optical communication device and a phase conjugated version of said second outgoing beam at said first communication device; returning said phase conjugated version of said first outgoing beam to said first optical communication device, and returning said phase conjugated version of said second outgoing beam to said second optical communication device such that said phase conjugated versions of said first and second outgoing beams track said respective first and second optical communication devices and contribute to the recording of said holographic gratings through positive feedback; and effecting information transfer between said optical communication devices over said signal beams reflected off said respective holographic gratings at each of said optical communication devices.

Phase-conjugate optics is a branch of nonlinear optics that deals with the generation, propagation, and application of phase-conjugated beams of light. Considering a light beam as the motion of a family of wave fronts in space, the phase-conjugate of that light wave has exactly the same set of wavefronts as the initial wave, but it moves in the opposite direction. Consequently, a phase-conjugated beam can be considered a time-reversed replica of an incident beam, capable of retracing the path of the incident beam. Phase conjugation is discussed in “Optical Phase Conjugation”, Akademic Press, New Yoir, 1982, R. A. Fisher ed., the contents of which are herein incorporated by reference.

The most common processes to generate a conjugate of a given wave, include: stimulated Brillouuin scattering, four-wave mixing, three-way wave mixing, or photon echoes. However, it is now understood that virtually any nonlinear optical effect can be used for this purpose, including photorefraction. The photorefractive effect occurs in photorefractive crystals, such as barium titanate (BaTiO₃) and strontium barium niobate (SBN).

When a photorefractive crystal is illuminated with two mutually coherent laser beams an interference fringe pattern is formed within the crystal. The fringe pattern causes a charge separation, which creates an electric field that, in turn, induces a change in the index of refraction due to Pockel's effect. This results in a volume index grating that affects the propagation of the light beams in the crystal (phase conjugation) and allows the exchange of energy between the beams (beam coupling). A phase-conjugated light wave is produced by a readout of the same frequency, counterpropagating to the mutually coherent write beam which diffracts of the index grating (volume hologram).

Phase conjugation technology is currently used to correct optical signal distortions presented by the laser light source due to thermal effects or non-ideal optics and light guiding systems. It could be used to correct aberrations imposed on a communication signal by atmospheric conditions, such as turbulence, diffraction, thermal blooming and aerosol scattering.

Double phase conjugation (DPC) is especially promising for use in bi-directional optical links because it provides mutual conjugation of two incoherent laser beams. The advantage of using DPC is that it allows achieving automatic, self-controlled coupling of beam emitters and receivers (e.g. optical fibers or distant telecommunication satellites). Double phase conjugation is discussed, for example, with reference to photrefractive crystals in “Phase Conjugation”, Nauka, Moscow, 1985, N. Ya Zeldovich, N. F. Pilipetskii, and V. V. Shkunov, the contents of which are herein incorporated by reference.

In another aspect the present invention provides an optical communication device for use in a system for optical bi-directional self-tracking communication through free space comprising a pair of optical communication devices, said optical communication device comprising a single-mode fiber for combining a pilot beam and a signal beam to create a combined outgoing beam; an output element for diverging said outgoing beam so that said divergent output beam can propagate through free space toward the other optical communication device; a non-linear optical element in the path of said outgoing beam and an incoming non-phase conjugated beam from the other optical communication device for dynamically recording a holographic grating that creates a phase conjugated version of said incoming non-phase conjugated beam; and an element for directing an incoming phase conjugated beam that is a phase conjugated version of said outgoing beam created at the other optical communications device toward said non-linear element so as to enhance said recording of said holographic grating through positive feedback; and whereby information can be transferred to the other optical communications device on said signal beam reflected off said holographic grating.

Thus, the invention provides a novel, all-optical approach in beam control/deflection/tracking techniques based on combination of optical wave phase conjugation and optical dynamic holography. Such an approach is suitable for achieving automatic, self-controlled coupling of beam emitters and receivers (e.g. optical fibers or distant telecommunication satellites). The method and the apparatus is proposed, both based on using nonlinear optical materials, in which the so-called Double Phase Conjugation (DPC) process can be realized with low light intensity. Combining the DPC phenomenon with dynamically recorded diffraction grating in these materials allows the establishment of a bi-directional optical link between an optical transmitter and a receiver with an automatic tracking feature. The invention can eliminate the need for ultra-precise mechanical steering elements as well as complicated positioning and addressing computing. An important result is the potential increase in the performance levels of both the ground optical fiber and intersatellite communication links.

### BRIEF DESCRIPTION OF THE DRAWINGS

The invention will now be described in more detail, by way of example only, with reference to the accompanying drawings, in which:—

FIG. 1a is a diagrammatic view of a DPC steering module of a holographic/phase conjugation optical transceiver;

FIG. 1b is diagrammatic view of the OISL communications system illustrating the interaction of two satellite terminals;

FIG. 2 is a vector diagram of wave interaction in a nonlinear medium; and

FIG. 3 is the plot of the threshold coupling constant L as a function of pilot beam intensity ratio for a system in accordance with one embodiment of the invention.

### DESCRIPTION OF THE PREFERRED EMBODIMENTS

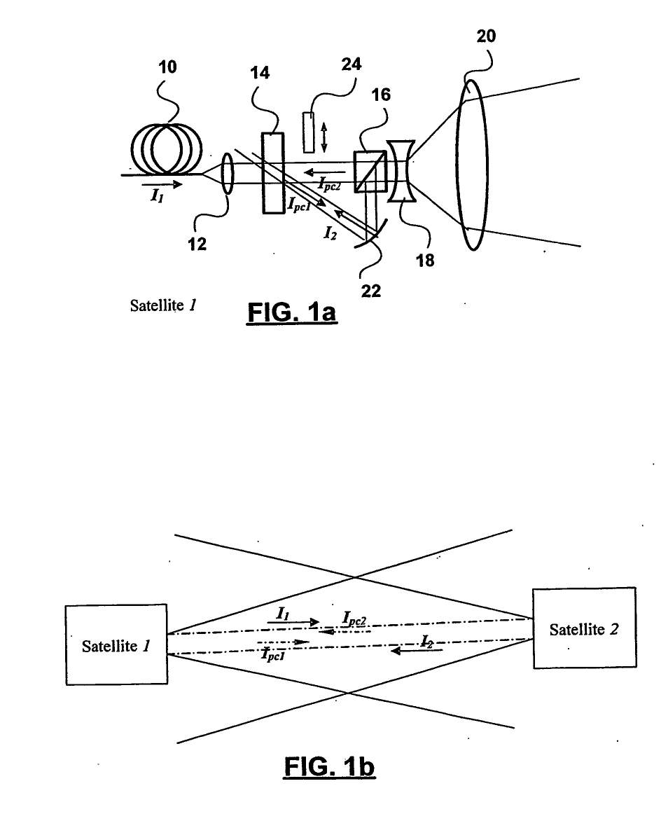

FIGS. 1a and 1b illustrate how DPC may be used to link two distant lasers on respective satellites 1, 2. A communication fiber 10 is used for carrying a signal beam providing information transfer and a pilot beam. It is assumed that both beams propagate in the same fiber 10, which will allow for precise matching of the directions and transverse structures of these two optical beams. The beam I₁ referred to below is the summed composition of both the pilot and signal beams.

The summed composition of pilot and signal beams I₁ is collimated at the output of the fiber 10 in a collimator lens 12 and passed through the nonlinear medium 14 that exhibits third-order optical non-linearity, such as a BTiO₃ or SBN photorefractive crystal. Third-order optical non-linearity means that the refractive index is depend on intensity of the light. Thus, an interference pattern of two coherent optical waves will induce a holographic grating.

A portion of the beam I₁ is passed through the beam splitter 18 and through the input/output telescope comprising two lenses (or curvature mirrors) 18 and 20 providing sufficient output divergence of the beam I₁ to cover the uncertainty in the position of the other satellite location (satellite B). The central direction of the pilot beam I₁ is oriented toward the predicted position of the satellite 2. This preliminary orientation can be implemented by rotation of the whole tracking system or by steering a mirror installed at the exit of the tracking system. The interception of the satellite 2 would be ensured by an appropriate divergence of the beacon beam. If the uncertainty of satellite 2 location is too large, a preliminary scanning may be necessary.

The terminal of satellite 2 features a matching transceiver producing similar beam I₂. Part of this beam I₂, is received by the aperture of the input/output telescope of satellite 1 (lenses 20, 18) and is divided by the beam splitter 16. Part of the divided beam I₂ is passed to a curvature mirror 22, from which it is reflected and focused on the nonlinear medium 14. If the intensities of the two beams I₁ and I₂ in the nonlinear medium 14 are sufficient, the formation of phase-conjugated beams is induced. As shown in FIG. 1a, the phase conjugated beam I_{pc2} passes directly through the beam splitter 16 to the non-linear element 14.

Two phase-conjugated beams are produced by means of the DPC process as described in “D. Udaian, K. S. Syed, R. P. M. Green, D. H. Kim, and M. J. Damzen, “Transient modelling of double-pumped phase conjugation in inverted Nd:YAG”, Optics Communications, 133, pp. 596-604, 1997.”, the contents of which are herein incorporated by reference.

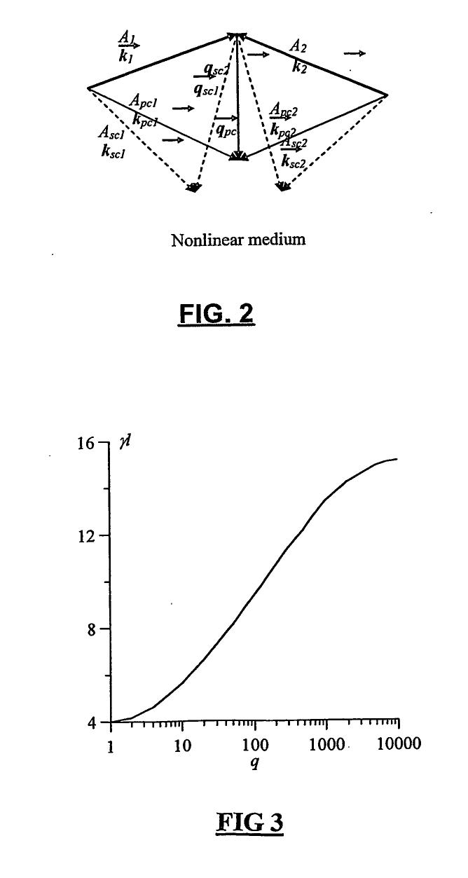

This phenomenon can be explained in the following way. Let us assume that two optical waves with complex amplitudes of electric field A₁ and A₂ enter the nonlinear medium 14 from opposite sides (FIG. 2). Each optical wave produces scattering waves propagating in different directions. The scattering waves interfere with each initial wave producing holograms enabling their amplification due to reflection of initial waves from the holograms. The scattering waves that are phase conjugated to each initial wave A_{pc1}, and A_{pc2} get much more amplification because they use the same hologram. The joint hologram plays the role of providing positive feedback in the growth of two counter-propagating scattering processes that lead to parametric generation of phase conjugated waves.

Since the DPC process is caused by the formation of a joint hologram that reflects each pilot beam towards the other, this hologram may be used for reflection of the signal beams. The fact that the signal beam and the pilot beam have the same direction and structures is significant since it ensures that both beams reflected from the hologram are phase conjugated to the incoming beams. Thus conjugated part of the outgoing signal beam will be ideally coupled to the single-mode communication fiber located on the other satellite 2.

The feasibility of this approach using available nonlinear optical materials can be demonstrated. The main parameter critical for realization of DPC is nonlinear optical gain γ that characterizes energy transfer from a powerful pilot beam to phase conjugated beam starting from the scattering level. According to Udaian supra, DPC may be realized when the following threshold condition is satisfied:

$$\begin{matrix}s = tanh ( \frac{γ L}{4} \cdot s ) & ( 1 ) \\ s = \vert \frac{1 - q}{1 + q} \vert & ( 2 )\end{matrix}$$

wherein, L is the nonlinear medium length, and q=I₁/I₂ is the intensity ratio of the beams I₂,I₂. In practice, case of interest arises when q is much more than unity. Indeed, only small part of beam I₂ will reach the aperture of the satellite 1 large area of location uncertainty of this satellite must be covered.

The plot of the threshold coupling constant X as a function of beam intensity ratio is shown in FIG. 3. In photorefractive crystals, such as BTiO₃ or SBN, the exponential gain coefficients γ can be as large as 20 cm⁻¹ in the visible range at several mW power of interacting beams as described in: “P. Yen, “Introduction to photorefractive nonlinear optics”, A Willey-Interscience publication, New York, 1993,” “E. J. Sharp, W. W. Clark 111, M. J. Miller, G. L. Wood, B. Monson, G. J. Salamo, and R. R. Neurganokar, “Double phase conjugation in tungsten bronze crystals”, Applied Optics, 29, pp. 743-749, 1990,” and in Udaian supra. Thus DPC at beam intensity ratio 10³-10⁴ (put 10³) is reliable in such crystals with a length of 1 cm. Further increase of intensity ratio q is not reasonable since parasitic scattering and reflections from output optics may occur in this case.

The focusing of the beam I₂ onto the photorefractive crystal is assumed to give a beam diameter d₂ varying from 2.5 μm to 1400 gm along all crystal length (put d₂=100 μm). For the outgoing beam I₁, the diameter d₁=1.5 cm is suggested. This diameter ratio ensures a high fidelity of phase conjugation for the outgoing beam, enabling high efficiency of coupling of outgoing beam and communication fiber in satellite 2 as described in: “P. Gunter and J.-P. Huignard eds., “Photorefractive materials and their applications I”, Shpringer-Verlag, Berlin, 1988.”, the contents of which are herein incorporated by reference.

Assuming an aperture for the output/input telescope Dₜₑₗ=25 cm and equal powers of both pilot beams at the exit of each satellite, the diameter of the pilot beam I₂ at the location of satellite 1 can be estimated in the following way:

$$D = \frac{{d}_{1}}{{d}_{2}} \cdot {D}_{tel} \sqrt{q} \qquad ( 3 )$$

This estimate gives us D≈1 km. For OISL between low-orbit satellites at distances of about 1000 km, this will correspond to covered angular uncertainty θ_{cover} of about 1 mrad. This value is not far from typical angular uncertainty that may be from 1.4 mrad to 7 mrad.

The DPC threshold is achieved. In FIG. 1b, I₁ and I₂ represent the outgoing beams from satellites 1 and 2 respectively. I_{pc1} and I_{pc2} represent the two phase conjugated beams returned from the corresponding satellites. This results in further growth of the diffraction efficiency of a joint holographic grating. This may be explained with reference to the example of satellite 1 (FIGS. 1a and 1b). Contrary to the initial stage of the DPC process, where the grating was initially written by the beam I₂ and its spontaneous scattering and small seeding toward phase conjugated mode, the phase conjugated beam I_{pc2} now works as a strong seed for the hologram writing process. Due to such seeding, the hologram effects additional recording and its diffraction efficiency is increased, enabling an increase in the power of the phase conjugated beams. Thus, now the feedback between two crystals located on the two satellites 1 and 2 is self-induced, and the two crystals work as one integrated DPC system. This feedback turns out to be positive as the power of the phase conjugated beams and holograms reflectivity increases.

The growth is limited by depletion of pilot beams in the area of their intersection. If the angle of pilot beams intersection (FIGS. 1a and 1b) is about 45°, the area of their intersection is about 0.14 cm×1.5 cm, that is 10% of the total square of pilot beam I₁. Assuming full depletion of the beam I₁ in that area, 10% of its power (and as consequence 10% of power of communication beam) may be transferred to the phase conjugated beam. However, only part of this power will reach the communication channel on satellite 2 because of non-perfect phase conjugation. The phase conjugation error is based on the fact that only small part of beam is conjugated due to the finite incoming/outgoing aperture. This limitation may be expressed as limitation of divergence θ_{pc} of conjugated beam:

θ_{pc}=λ/Dₜₑₗ (4)

where λ is wavelength, assuming A=500 nm for θ_{pc} obtain 2 μrad. This gives a spot size for conjugated beam at the receiver location ˜2 m, that is 8 times more than the receiver aperture. Such aperture losses decrease the transmission coefficient from 10% to 0.15%.

Thus, the basic steps in the operation of this system may be summarized in the following phases.

1. Orientation of the pilot beams toward the predicted satellite locations.

2. Build up of the holographic gratings, enabling the DPC in each satellite.

3. Build up of the inter-satellite optical feedback, resulting to steady-state reflectivity of the holograms.

4. Information transfer.

When the hologram reaches its steady-state, the information transfer is activated. The transfer is not interrupted as a result of relative movement of the satellites so long as both satellites keep each other in field of view (in the angle of θ_{cover}). In practice, this means that the hologram is continuously correcting (not fully rewritten, but affected by small correction) by changing of the pilot beam directions. From this point, the speed of angular tracking can be estimated in the following form:

$$φ = \frac{{ϑ}_{cover}}{τ} \qquad ( 5 )$$

where τ is time of grating build up. In the example of photorefractive crystals BTiO₃ or SBN the time of grating build up lies in the range of 50-200 ms. Thus for φ, we get an estimate of 5-20 mrad/s. If the linear relative speed of the satellites is in the order of 8 km/s at distance between them 1000 km, this a gives limitation on φ in order of 8 mrad/s, which is in reliable range. Thus, the use of DPC concept in OISL seems is feasible.

The critical parameters for materials needed for the realization of DPC approach in OISL are nonlinear gain γ≧20 cm⁻¹ and grating build up time τ≦50 ms. As mentioned above, these parameters can be realized in a number of photorefractive crystals in the visible range. However, in the preferred case this system should be compatible with on ground fiber communication network. The operating wavelength of the OISL should be in the range of 1.3-1.6 μm.

The last requirement produces the main challenge since the nonlinear medium should be sensitive in that range. Promising results concerning DPC in that range have been observed with Cr—, Fe—, and V— doped cubic semi-insulating crystals, such as CdTe, GaAs, and InP. However, their use should be accompanied by the application of a high voltage (to provide a dc field as much as 20 kVcm⁻¹). Such as high field is unacceptable in a vacuum satellite environment. Multi-composite polymeric photorefractive materials and doped liquid crystals may be suitable for this purpose. A nonlinear gain up to 1000 cm⁻¹ has been already demonstrated in such materials in visible range. See “Double-phase-conjugation mirror in CdTe:V with elimination of conical diffraction at 1.54 μm”, Optics Letters, 20, pp. 937-939, 1995. The possibility of expanding the area of their applicability to IR range is quite reliable due to the high flexibility in the variation of their properties by chemical development of new materials and components.

In an alternative embodiment, it is possible to use a four-wave mixing architecture for the DPC. In FIGS. 1a and 1b, a partial reflective mirror 24 is inserted to provide backward reflection of the pilot beam I₁. In this case, there is no threshold for hologram formation because it is written by incoming beam I₂ and supporting beam I₁′ (backward reflection of pilot beam I₁). This has much greater intensity than scattering beam and seeding I_{pc2} in case of a parametric DPC (FIGS. 1a and 1b without mirror 24). High values of reflectivity can be achieved when the coupling coefficient (or gain in photorefractive crystals) |γ1|≈1. This can be realized in a number of materials, for example, in liquids with thermal nonlinearity as described in “A photorefractive polymer with high optical gain and diffraction efficiency near 100%”, Nature, 371, pp 497-500, 1994, the contents of which are herein incorporated by reference. However, instead of stringent requirements for nonlinear medium, there are stringent requirements for the laser sources. The main challenge here is to provide coherence of the two pilot beams from separate satellites. In reality, this can be achieved if the pilot beams that a have pulse periodic structure, and the pulse duration rp is less than the inverted frequency difference of the two pilot waves. This requires a pulse duration in the order of 0.1-1 ns. This presents an additional challenge in directing of the pilot beam into the single- mode fiber because of optical break down, stimulated Raman scattering in the fiber and other undesirable effects arising at pulse energies in order of hundreds of μJ. In principle, the communication signals may be adjusted with pilot beam in free space (not by directing them in the same fiber), but in this case their directions and especially transverse structures will not be the same, resulting in reflection of the communication signal from the hologram in the wrong direction with a structure that is not phase conjugated.

It will be seen that in accordance with the principles of the invention, the use of the DPC phenomenon (either in parametric or in four-wave mixing variants) can avoid the need for heavy and slow high-precision mechanics and shows promise in achieving data rates as high as those achievable with on-ground fiber optic communication.

1. A method of establishing bi-directional self-tracking optical communication through free space between first and second optical communication devices, comprising:
generating at said first and second optical communication devices respective first and second outgoing beams, each of said first and second outgoing beams comprising a signal beam and a pilot beam;
diverging said first outgoing beam and transmitting said divergent first outgoing beam from said first optical communication device toward said second optical communication device, and diverging said second outgoing beam and transmitting said divergent second outgoing beam from said second optical communication device toward said first optical communication device;
dynamically recording at each of said first and second optical communication devices a holographic grating with said first and second outgoing beams thereby creating a phase conjugated version of said first outgoing beam at said second optical communication device and a phase conjugated version of said second outgoing beam at said first communication device;
returning said phase conjugated version of said first outgoing beam to said first optical communication device, and returning said phase conjugated version of said second outgoing beam to said second optical communication device such that said phase conjugated versions of said first and second outgoing beams track said respective first and second optical communication devices and contribute to the recording of said holographic gratings through positive feedback; and
effecting information transfer between said optical communication devices over said signal beams reflected off said respective holographic gratings at each of said optical communication devices.

2. A method as claimed in claim 1, wherein said phase conjugated beams are formed in a non-linear optical device in which said holographic gratings are recorded.

3. A method as claimed in claim 2, wherein said non-linear optical device is a photorefractive crystal.

4. A method as claimed in claim 3, wherein said photorefractive crystal is selected from the group consisting of BTiO₃ or SBN.

5. A method as claimed in claim 3, wherein the operating wavelength of the optical communication devices is in the range 1.3-1.6 μm and said photorefractive crystal is selected from the group consisting of Cr—, Fe—, and V— doped cubic semi-insulating crystals.

6. A method as claimed in claim 4, wherein said photorefractive crystal is selected from the group consisting of CdTe, GaAs and InP crystals

7. A method as claimed in claim 6, wherein said respective first and second outgoing beams are passed through a beam diverger at the output of each said optical communications device.

8. A method as claimed in claim 7, wherein said respective first and second outgoing beams at each said optical communications device are first passed through said non-linear device and a beam splitter.

9. A method as claimed in claim 8, wherein said non-linear device returns a beam phase conjugated with said incoming non-phase conjugated beam via said mirror and said beam splitter, and an incoming phase conjugated beam passes through said phase splitter to said non-linear device.

10. A method as claimed in claim 9, wherein a partially reflective mirror is inserted in said source beams between said non-linear device and said beam splitter to provide partial backward reflection of said pilot beams and thereby provide four-wave mixing.

11. A method as claimed in claim 2, wherein said pilot beams intersect in said non-linear device at each said optical communication device, and wherein the diameter of the outgoing pilot beam is substantially larger than the diameter of the received pilot beam at the intersection.

12. An optical communication device for use in a system for optical bi-directional self-tracking communication through free space comprising a pair of optical communication devices, said optical communication device comprising:
a single-mode fiber for combining a pilot beam and a signal beam to create a combined outgoing beam;
an output element for diverging said outgoing beam so that said divergent output beam can propagate through free space toward the other optical communication device;
a non-linear optical element in the path of said outgoing beam and an incoming non- phase conjugated beam from the other optical communication device for dynamically recording a holographic grating that creates a phase conjugated version of said incoming non-phase conjugated beam; and
an element for directing an incoming phase conjugated beam that is a phase conjugated version of said outgoing beam created at the other optical communications device toward said non-linear element so as to contribute said recording of said holographic grating through positive feedback; and
whereby information can be transferred to the other optical communications device on said signal beam reflected off said holographic grating.

13. An optical communication device as claimed in claim 12, wherein said pilot beam is configured so that its diameter is substantially larger than the diameter of a pilot beam received from the other optical communication device.

14. An optical communication device as claimed in claim 13, wherein said non- linear optical element is a photorefractive crystal.

15. An optical communication device as claimed in claim 14, wherein said photorefractive crystal is selected from the group consisting of BTiO₃ or SBN.

16. An optical communication device as claimed in claim 14, wherein the operating wavelength of the optical communication devices is in the range 1.3-1.6 μm and said photorefractive crystal is selected from the group consisting of Cr—, Fe—, and V— doped cubic semi-insulating crystals.

17. An optical communication device method as claimed in claim 16, wherein said photorefractive crystal is selected from the group consisting of CdTe, GaAs and InP crystals.

18. An optical communication device as claimed in claim 12, further comprising a beam splitter located between said non-linear optical element and said output element for separating said incoming phase conjugated and non-phase conjugated beams.

19. An optical communication device as claimed in claim 18, further comprising a mirror for reflecting said incoming non-phase conjugated beam toward said non-linear optical element.

20. An optical communication device as claimed in claim 19, further comprising a partially reflective mirror between said non-linear optical element and said beam splitter to initiate four-wave mixing.

21. An optical communication device as claimed in claim 12, wherein said output element is a beam diverger/collimator.

22. An optical communication device as claimed in claim 12, wherein a partially reflective mirror is inserted downstream of said non-linear element to partially reflect said outgoing beam into said non-linear element to initiate four-wave mixing.
